(19) United States
(12) Patent Application Publication
(10) Pub. No.: US 2008/0094555 A1
(43) Pub. Date: Apr. 24, 2008

(54) Transflective liquid crystal display

(75) Inventors: Yi-Chun Wu, Hualien City (TW); Wen-Jui Liao, Taiping City (TW); Chun-Chi Chi, Longjing Township (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: Wintek Corporation, Tanzih Township (TW)

(21) Appl. No.: 11/975,595

(22) Filed: Oct. 19, 2007

(30) Foreign Application Priority Data
Oct. 20, 2006 (TW) 095138778

(51) Int. Cl. G02F 1/1335

(52) U.S. Cl. 349/114

(57) ABSTRACT

Two phase retardation compensation films with upper and lower slow axes being orthogonal to each other are used to clip a liquid crystal (LC) cell in a transflective liquid crystal display. In an orthogonal polarizer system, the axial difference between the slow axes of the retardation films and the LC molecules director in the LC cell is used to obtain the most suitable phase difference. The ON and OFF of the LC voltage are used to achieve the display function at the darkest state and the brightest state, so as to achieve a transmissive optical mode having low dispersion, wide viewing angle, and ultra-low dark state, without damaging the reflective mode.

### CROSS-REFERENCE TO RELATED APPLICATIONS

This non-provisional application claims priority under 35 U.S.C. § 119(a) on Patent Application No(s). 095138778 filed in Taiwan, R.O.C. on Oct. 20, 2006, the entire contents of which are hereby incorporated by reference.

### BACKGROUND OF THE INVENTION

1. Field of Invention

The present invention relates to a transflective liquid crystal display (LCD), and more particularly, to a transflective LCD that is capable of using the difference between slow axes of the retardation films and liquid crystal (LC) molecules director in the LC cell to obtain the most suitable phase difference in an orthogonal polarizer system.

2. Related Art

With the progress of the communication technology, people have paid more and more attention to the requirements and functions of the portable panel. In order to meet the requirements of power saving, outdoor legibility, and high color purity, the transflective LCD panel is applied in an increasingly wide scope. FIG. 1 shows a conventional transflective LCD. The fabricating method is that, the reflecting region B and the transmitting region A in the LC cell 10 are made to have different thickness with the ratio of 1:2 there-between, and the optical paths of the lights in different regions are made to be the same. In order to achieve the low dispersion effect, generally, the upper polarizer 11 and the lower polarizer 12 in the kind of optical compensation film are respectively used with the upper quarter-wave plate 13 and the lower quarter-wave plate 14 to form the circular polarization state, and then, the circular polarizing system is used together with the homogeneously-alignment LC cell 10 to achieve the transflective effect. In the figure, the light from the backlight module 15 passes through the lower polarizer 12 to form a linear polarized light, and the direction of the polarized light is as shown by the arrow 12a. Then, the light passes through the lower quarter-wave plate 14 to form a left-hand circularly polarized light, and the polarizing direction is as shown by the arrow 14a. Then, the light passes through the LC cell 10, wherein the LC molecules are arranged according to the alignment directions 10a and 10b. When the light reaches the upper quarter-wave plate 13, and forms a right-hand circularly polarized light, and the direction of the polarized light is as shown by the arrow 13a. Finally, the light passes through the upper polarizer 11 to form the linear polarized light, and the polarizing direction is as shown by the arrow 11a. The voltage of the thin film transistor is used to control the director direction of the LC molecules, so as to adjust the quantity of the light finally passing through the upper polarizer 11, and to achieve the effect of controlling the darkness. However, in order to simultaneously present the effects of the transmissive mode and the reflective mode, the displaying quality of the transmissive mode is usually deteriorated when the reflecting effect is enhanced.

In order to solve the above problems, a transflective LCD is disclosed in U.S. Pat. No. 6,654,087. When the voltage is OFF, the light source of the backlight module firstly passes through the lower polarizer plate to form the linear polarized light. Then, the light passes though the lower quarter-wave plate to form the right-hand circularly polarized light. Then, the light passes through the LC layer in the LC cell to form the left-hand circularly polarized light, and then, the light passes through the upper quarter-wave plate to form the linear polarized light. At this time, the linear polarized light is parallel to the transmissive axis of the upper polarizer plate, so that the screen shows the bright state. When the voltage is ON, the light passing through the LC layer forms the right-hand circularly polarized light, and the linear polarized light passing through the upper quarter-wave plate is orthogonal to the transmissive axis of the upper polarizer plate, so the screen shows the dark state. The lower quarter-wave plate makes the illumination of the transmissive mode and the reflective mode be equivalent to each other, and the LC layer thickness of the transmitting region is one time thicker than that of the reflecting region, thus, when the voltage is ON, the whole transflective LC screen shows the uniform dark state, and thereby enhancing the contrast of the screen.

To sum up, recently, the transflective LCD uses the optical compensation film including the circular polarized light system to solve the dispersion problem, so as to increase the screen brightness and to improve the contrast of the screen. When applying the transflective LCD of the circular polarizing system, the problem that the viewing angle cannot be enlarged and the problem of the gray-scale inversion cannot be solved. Therefore, it has become an important issue to provide a new optical compensating system, so as to eliminate the disadvantage of the transflective LCD.

### SUMMARY OF THE INVENTION

In order to solve the problems of the prior art, the present invention provides a transflective LCD, wherein two retardation films with upper and lower orthogonal slow axes are used to clip a LC cell, and the ON and OFF of the LC voltage are utilized to achieve the function of displaying the darkest state and the brightest state, so as to achieve the transmissive optical mode having low dispersion, wide viewing-angle, and ultra-low dark state, without damaging the reflective mode.

The transflective LCD provided by the present invention comprises a first polarizer; a first retardation film, located on the first polarizer; a LC cell located on the first retardation film and having a LC layer, wherein the LC alignment direction of the LC layer is orthogonal to a slow axis of the first retardation film, and the LC cell further comprises at least one transmitting region and at least one reflecting region; a second retardation film, located on the LC cell, wherein a slow axis of the second retardation film is parallel to the LC alignment direction of the LC layer; a second polarizer, located on the second retardation film; and a backlight module, located under the first polarizer. The first retardation film and the second retardation film may be made of the materials of PC, Arton, Sina, Zeonor, or liquid crystal polymer film (LCP film), etc.

In the present invention, the LC cell, the first retardation film, and the second retardation film are used together to achieve the suitable phase difference and the slow axis angle, and then, the orthogonal polarizer system is used to achieve the preferred transmissive optical mode, without damaging the reflective mode.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, which thus is not limitative of the present invention, and wherein:

FIG. 1 is a schematic view of a conventional transflective LCD;

FIG. 2 shows a first embodiment of the present invention;

FIG. 3A is a reflectance of the reflective mode of the first embodiment of the present invention under different LC voltages;

FIG. 3B is a transmission of the transmissive mode of the first embodiment of the present invention under different LC voltages;

FIGS. 4A to 4D show a second embodiment of the present invention;

FIG. 5A is a reflectance of the reflective mode of the second embodiment of the present invention under different LC voltages;

FIG. 5B is a transmission of the transmissive mode of the second embodiment of the present invention under different LC voltages;

FIG. 6A is a reflectance of the reflective mode of a third embodiment of the present invention under different LC voltages;

FIG. 6B is a transmission of the transmissive mode of the third embodiment of the present invention under different LC voltages;

FIG. 7A is a horizontal viewing angle of the conventional transflective LCD in the transmitting region;

FIG. 7B is a horizontal viewing angle of the first embodiment of the present invention in the transmitting region;

FIG. 7C is a horizontal viewing angle of the second embodiment of the present invention in the transmitting region;

FIG. 7D is a horizontal viewing angle of the third embodiment of the present invention in the transmitting region;

FIG. 8A is a vertical viewing angle of the conventional transflective LCD in the transmitting region;

FIG. 8B is a vertical viewing angle of the first embodiment of the present invention in the transmitting region;

FIG. 8C is a vertical viewing angle of the second embodiment of the present invention in the transmitting region; and

FIG. 8D is a vertical viewing angle of the third embodiment of the present invention in the transmitting region.

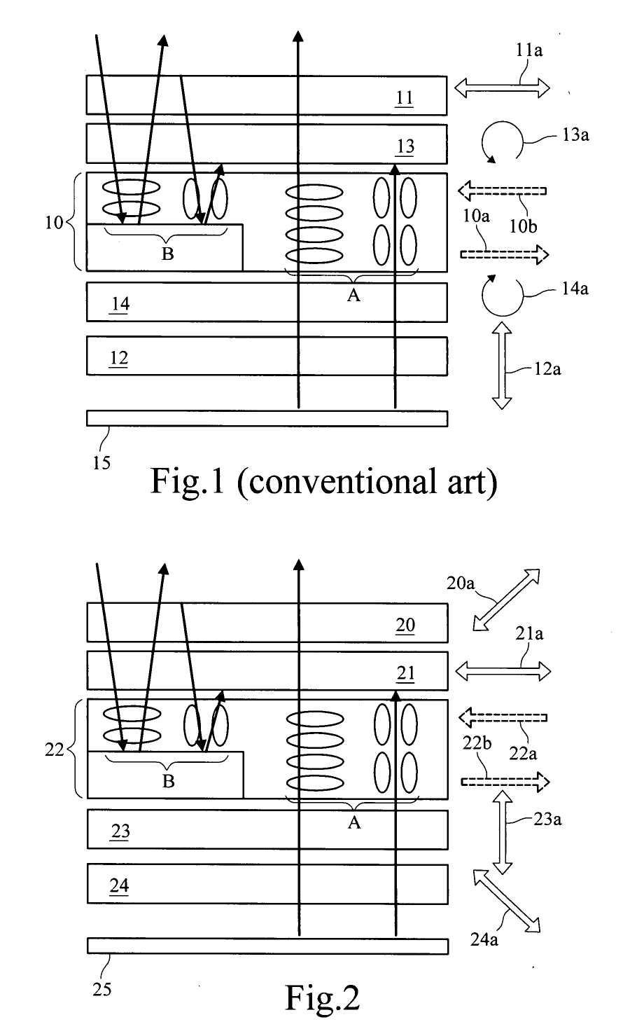

### DETAILED DESCRIPTION OF THE INVENTION

In order to make a further understand the objective, construction, feature, and function of the present invention, the detailed description is given below through the embodiments. The above description of the summary of the present invention and the following detailed description of the present invention are used to exemplify and explain the principle of the present invention, and to provide the further explanation of the claims of the present invention.

Referring to FIG. 2, it shows a first embodiment of the present invention. The transflective LCD includes a first polarizer 24, a first retardation film 23, a LC cell 22, a second retardation film 21, a second polarizer 20, and a backlight module 25. The first retardation film 23 is located on the first polarizer 24. The LC cell 22 is located on the first retardation film 23 and has a LC layer. The LC alignment directions 22a and 22b of the LC layer are orthogonal to the slow axis direction 23a of the first retardation film 23. The LC cell 22 further includes a transmitting region A and a reflecting region B, wherein the LC molecules of the LC layer are homogeneously arranged. The second retardation film 21 is located on the LC cell 22, wherein an slow axis direction 21a of the second retardation film 21 is parallel to the LC alignment directions 22a and 22b of the LC layer. The second polarizer 20 is located on the second retardation film 21. The backlight module 25 is located under the first polarizer 24. The polarizing direction 24a of the first polarizer 24 is orthogonal to the polarizing direction 20a of the second polarizer 20.

In an orthogonal polarizer system, the corresponding relationship between the slow axis direction 23a of the first retardation film 23 and the slow axis direction 21a of the second retardation film 21 is used, and when the LC voltage is OFF, the phase difference between the first retardation film 23 and the second retardation film 21 and the phase difference of the LC cell 22 are used to make the equivalent phase difference in the whole optical system be equal to the half wavelength, thereby achieving the highest brightness. When the LC voltage is ON, only the remaining horizontal phase difference in the LC cell 22 counteracts with the phase difference between the first retardation film 23 and the second retardation film 21, so as to make the equivalent phase difference in the whole optical system be close to zero, thereby achieving the lowest dark state, together with an orthogonal polarizer system.

In the first embodiment, the slow axis direction 21a of the second retardation film 21 is parallel to the LC alignment directions 22a and 22b, and the slow axis direction 23a of the first retardation film 23 is orthogonal to the LC alignment directions 22a and 22b, thus, if subtracting the phase difference of the first retardation film 23 from the sum of the phase difference of the second retardation film 21 and the phase difference of the LC cell 22, the phase difference in the orthogonal polarizer system when the LC voltage is OFF is obtained. When this phase difference value approaches 260-290 nm, the optical mode has the optimal transmissive brightness, which is the bright state. When the LC voltage is ON, the effective phase difference equals to subtracting the phase difference of the first retardation film 23 from the sum of the phase difference of the second retardation film 21 and the remaining phase difference of the LC cell 22, and when this effective phase difference value approaches to zero, the dark state is generated.

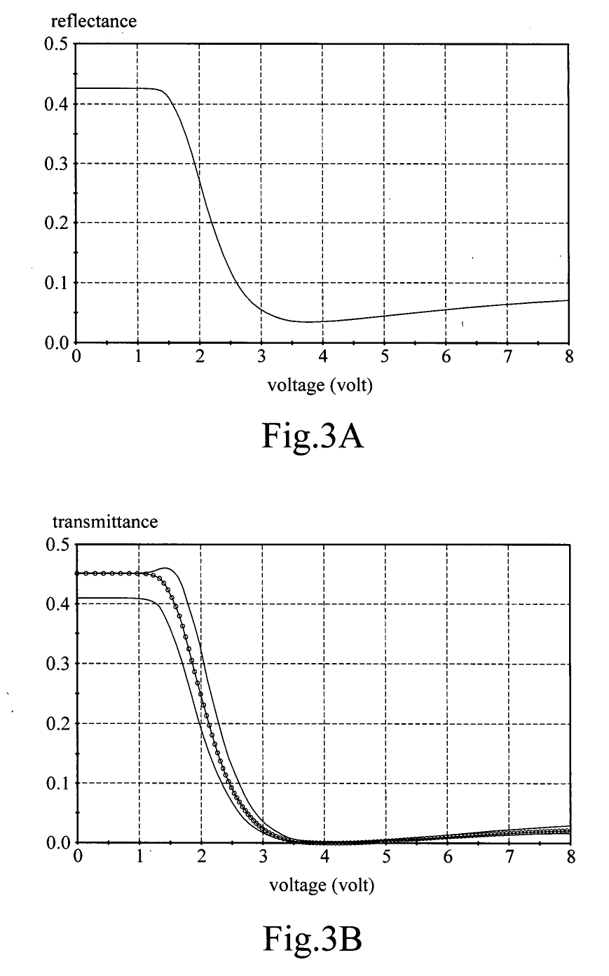

Referring to both FIGS. 3A and 3B, the optical testing result of the first embodiment is illustrated. FIG. 3A is a reflectance of the reflective mode under different voltages. FIG. 3B is a transmittance of the different wavelength light source under different voltages for the transmissive mode. In the first embodiment, the transmission axis of the second polarizer 20 is 45 degrees, the slow axis angle of the second retardation film 21 is 90 degrees and the phase difference value is equal to 80 nm, the phase difference value of the reflecting region B of the LC cell 22 is 190 nm, and the phase difference value of the transmitting region A is 320 nm, the slow axis angle of the first retardation film 23 is 0 degrees, and the phase difference value is 150 nm, the transmission axis of the first polarizer 24 is −45 degrees. The reflectance contrast ratio of the first embodiment is 11.8, and the transmittance contrast ratio is 9020. In FIG. 3B, the low dispersion distribution and the darkest state effect of the transmissive mode may be observed.

The material of the first retardation film 23 and the second retardation film 21 may be replaced by the hybrid liquid crystalline polymer layer (LCP film). As long as the phase difference value of the retardation film is 60-190 nm, or the LC tilt angle of the LCP film is 30-70 degrees, and the phase difference value is 80-160 nm, the retardation film can be used together with the LC cell 22 to generate the function described in the present invention. Moreover, when the phase difference value of the transmitting region A of the LC cell 22 is 200-380 nm, the phase difference value of the reflecting region B is 100-200 nm, the function described in the present invention can be achieved, together with the orthogonal polarizing compensating system.

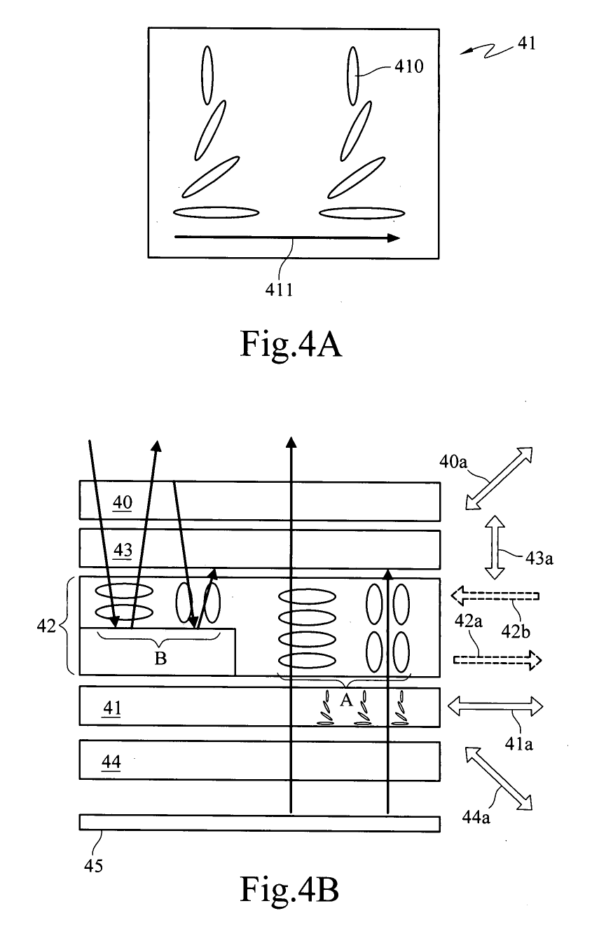

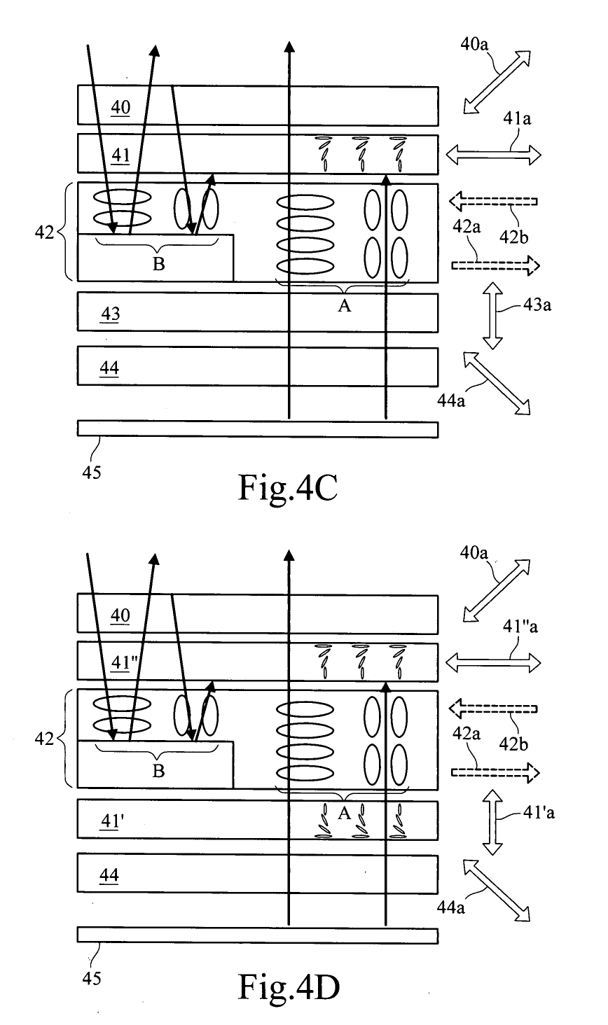

Next, referring to FIGS. 4A to 4D, the second embodiment of the present invention is shown. Besides the retardation films, the LCP film is used in this embodiment to replace any one or two of the retardation films to perform the optical compensation. As shown in FIG. 4A, the LCP film 41 has LC molecules 410 with a predetermined tilt angle and a phase difference, and the LCP film 41 may be fabricated by adhering or coating process, and in this embodiment, the LCP film 41 is adhered on the outer side of the LC cell 42. Definitely, the LCP film 41 may also be coated on the inner and outer sides of the LC cell 42.

Moreover, the LCP film 41 also has the axis of LC alignment 411. As shown in FIG. 4B, the LCP film 41 is located on the first polarizer 44, the LC cell 42 is located on the LCP film 41, the LC alignment directions 42a and 42b of the LC cell 42 are parallel to the LC optical axis direction 41a of the LCP film 41, and the LC cell 42 further includes a transmitting region A and a reflecting region B. The LC molecules of the LC layer are homogeneously arranged. The retardation film 43 is located on the LC cell 42, wherein the slow axis direction 43a of the retardation film 43 is orthogonal to the LC alignment directions 42a and 42b of the LC layer. The second polarizer 40 is located on the retardation film 43. The backlight module 45 is located under the first polarizer 44. The polarizing direction 44a of the first polarizer 44 is orthogonal to the polarizing direction 40a of the second polarizer 40.

As shown in FIG. 4C, the retardation film 43 is located on the first polarizer 44. The LC cell 42 is located on the retardation film 43, the LC alignment directions 42a and 42b of the LC cell 42 are orthogonal to the slow axis direction 43a of the retardation film 43, and the LC cell 42 further includes a transmitting region A and a reflecting region B. The LC molecules of the LC layer are homogeneously arranged. The LCP film 41 is located on the LC cell 42, and the LC optical axis 41a of the LCP film 41 is parallel to the LC alignment directions 42a and 42b of the LC layer. The second polarizer 40 is located on the LCP film 41. The backlight module 45 is located under the first polarizer 44. The polarizing direction 44a of the first polarizer 44 is orthogonal to the polarizing direction 40a of the second polarizer 40.

As shown in FIG. 4D, the first LCP film 41′ is located on the first polarizer 44. The LC cell 42 is located on the first LCP film 41′, the LC alignment directions 42a and 42b of the LC cell 42 are orthogonal to the LC optical axis 41′a of the first LCP film 41, and the LC cell 42 further includes a transmitting region A and a reflecting region B. The LC molecules of the LC layer are homogeneously arranged. The second LCP film 41″ is located on the LC cell 42, wherein the LC optical axis 41″ a of the second LCP film 41″ is parallel to the LC alignment directions 42a and 42b of the LC layer. The second polarizer 40 is located on the LCP film 41″. The backlight module 45 is located under the first polarizer 44. The polarizing direction 44a of the first polarizer 44 is orthogonal to the polarizing direction 40a of the second polarizer 40.

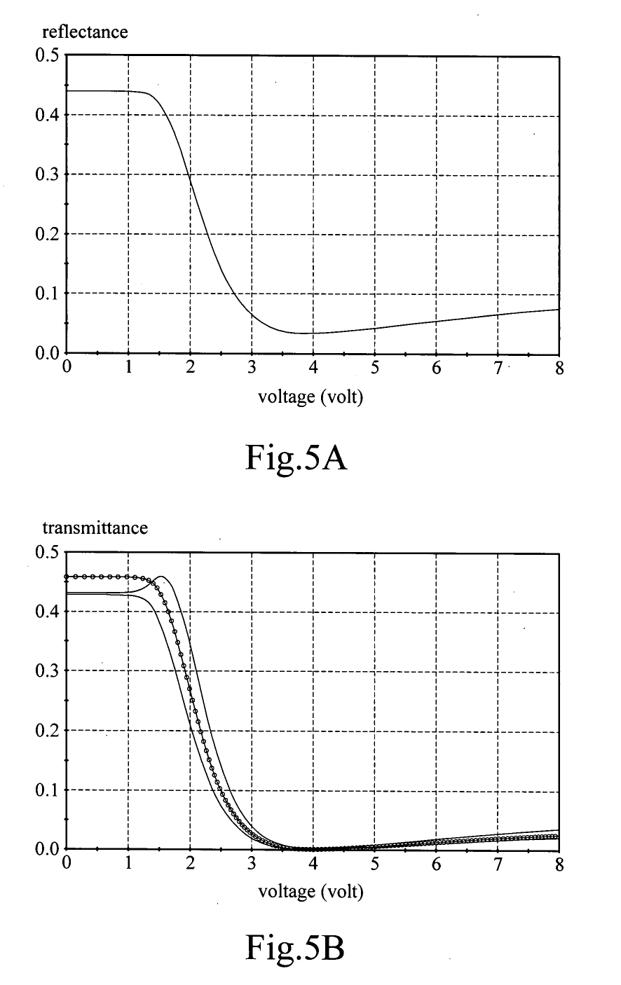

Referring to FIGS. 5A and 5B, the optical testing result of the second embodiment is illustrated. FIG. 5A is a reflectance of the reflective mode under difference LC voltages. FIG. 5B is a transmittance of the different wavelength light source under difference LC voltages for the transmissive mode. In the second embodiment, the LC molecules of the LC layers are homogeneously arranged, and the alignment direction of the LC molecules is 90 degrees, the transmission axis of the second polarizer 40 is 45 degrees, the LC optical axis 41a of the LCP film 41 is parallel to the LC alignment directions 42a and 42b of the LC cell 40, and the phase difference value of the LCP film 41 is 110 nm, and the LC tilt angle is 50 degrees. The phase difference value of the reflecting region B of the LC cell 40 is 180 nm, and the phase difference value of the transmitting region A is 340 nm. The slow axis of the retardation film 43 is 0 degrees, and the phase difference value is 160 nm. The transmission axis of the first polarizer 44 is −45 degrees. The reflectance contrast ratio of the second embodiment is 12.9, and the transmittance contrast ratio is 8612. It is observed from FIG. 5B that, under the transmissive mode, the optical compensating system of the second embodiment has the advantages of low dispersion and lowest dark state.

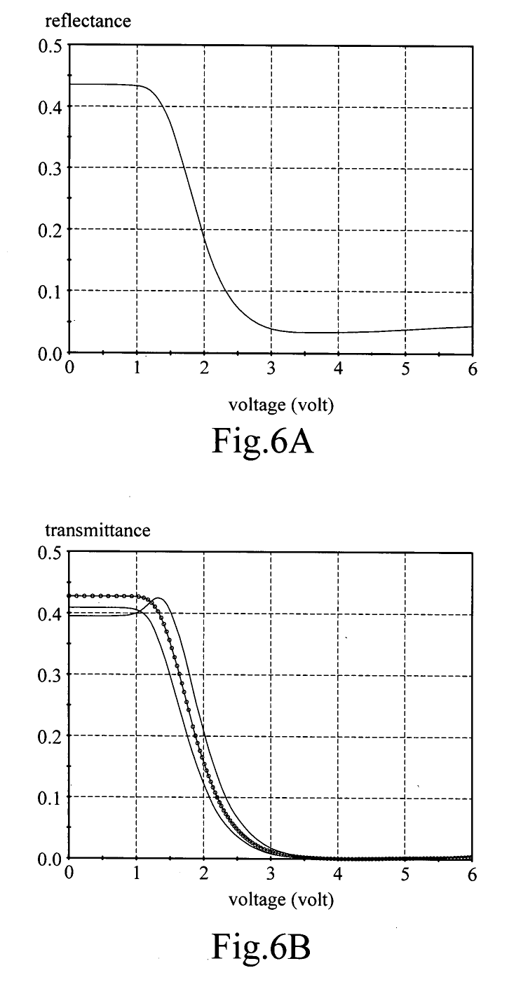

Besides the homogeneously arranged LC cell, the optical compensating mechanism of the present invention may also be suitable for the LC cell with a small twist angle. In the third embodiment, the retardation film and the optical construction are the same as that of the first embodiment, with the only difference lying in that, the LC cell has the twisting effect. The third embodiment is illustrated with reference to the relative position of each element in FIG. 2. In the third embodiment, when the transmission axis of the second polarizer 20 is 45 degrees, the slow axis angle of the second retardation compensation film 21 is 90 degrees, and the phase retardation is 110 nm. The LC molecules in the LC cell 22 have an effect of twisting for 30 degrees. Moreover, the first retardation film 23 is located on the first polarizer 24, and the slow axis direction 23a of the first retardation film 23 is orthogonal to the center direction of the twist angle of the LC molecules in the LC layer. The second polarizer 20 is located on the second retardation film 21, the slow axis direction 21a of the second retardation film 21 is parallel to the center direction of the twist angle of the LC molecules in the LC layer. The backlight module 25 is located under the first polarizer 24. The polarizing direction 24a of the first polarizer 24 is orthogonal to the polarizing direction 20a of the second polarizer 20. Furthermore, the phase difference value of the reflecting region B of the LC cell 22 is 112 nm, and the phase difference value of the transmitting region A is 224 nm. The slow axis of the first retardation film 23 is 0 degrees, and the phase difference value is 160 nm. The transmission axis of the first polarizer 24 is −45 degrees. Referring to FIGS. 6A and 6B, the optical testing result of the third embodiment is illustrated. FIG. 6A is a reflectance of the reflective mode under difference LC voltages. FIG. 6B is a transmittance of the different wavelength light source under different LC voltages for the transmissive mode. The reflectance contrast ratio of the third embodiment is 12.8, and the transmittance contrast ratio is 4040. Therefore, in addition to being used together with the homogeneously-arranged LC cell, the optical compensating mechanism of the present invention may be used with the LC cell with the twisting effect. The LC twist angle of the LC layer in the LC cell may be 0-50 degrees. The suitable upper and lower retardation films are used to counteract with the remaining phase difference of the LC cell, so that the dark state with low brightness is generated, and the optical characteristics with a high contrast is achieved.

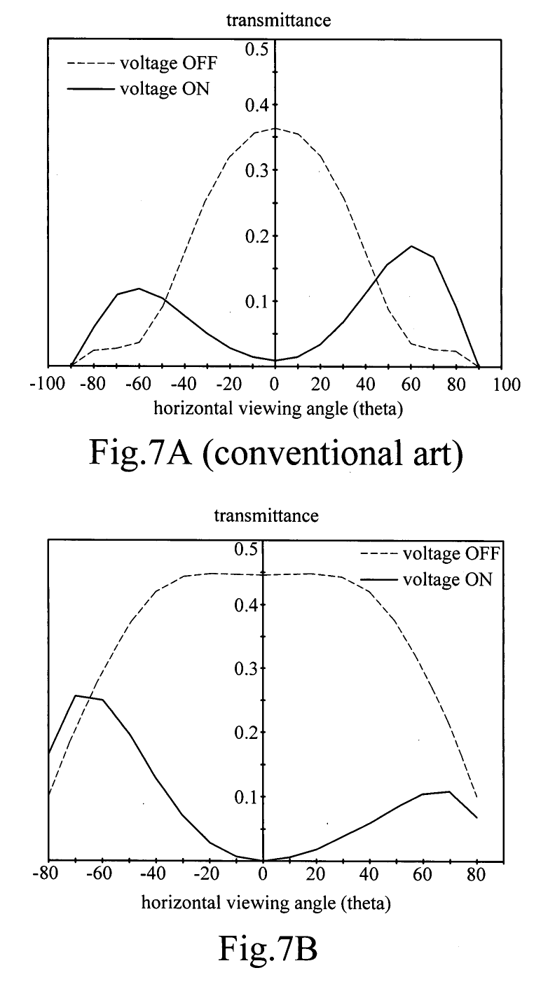

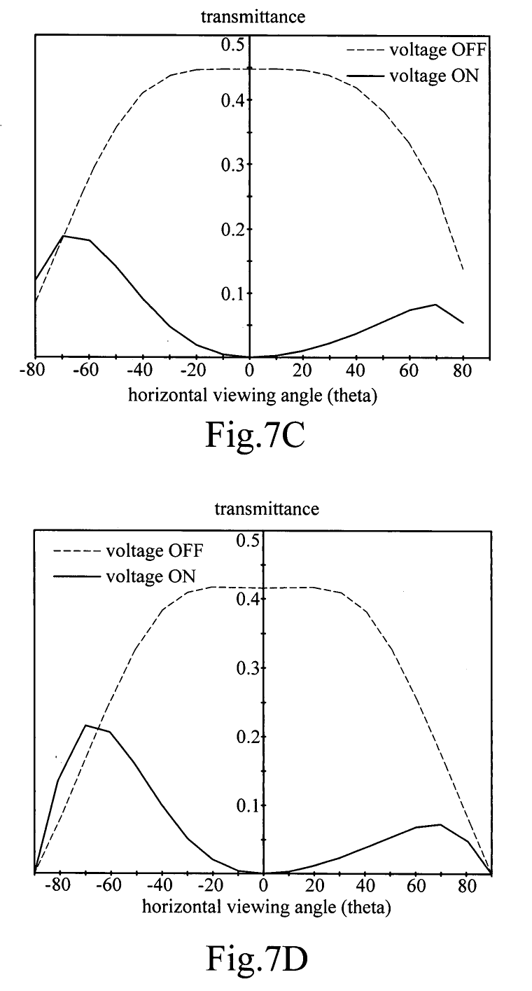

Next, referring to FIGS. 7A to 7D, they are horizontal viewing angle characteristics of the transflective LCDs of the conventional circular polarizing compensating system and the transflective LCDs of the first to third embodiments of the present invention in the transmitting region. FIG. 7A is a horizontal viewing angle characteristic of the transflective LCD of the conventional wide-band circular polarizing compensating system in the transmitting region. The transmittance curve when the LC voltage is OFF and that when the LC voltage is ON are crossed with each other near the horizontal viewing angle of 40 degrees and near the horizontal viewing angle of −50 degrees, and the gray-level inversion problem occurs for the horizontal viewing angle at the cross points, such that it is impossible to enlarge the viewing angle. FIG. 7B is a horizontal viewing angle characteristic of the first embodiment in the transmitting region. The gray-level inversion occurs near the horizontal viewing angle of −65 degrees, such that the horizontal viewing angle is wider than the conventional horizontal viewing angle. FIG. 7C is a horizontal viewing angle characteristic of the second embodiment in the transmitting region. The gray-level inversion occurs near the horizontal viewing angle of −70 degrees, thus, the structure of the second embodiment makes the transmitting region have preferred viewing angle characteristic than that of the first embodiment, that is, the compensating effect of the LCP film is better than that of the retardation film. FIG. 7D is a horizontal viewing angle characteristic of the third embodiment in the transmitting region. The gray-level inversion is generated near the horizontal viewing angle of −65 degrees and the horizontal viewing angle of 90 degrees. Since the LC cell has the twisting effect, the viewing angle characteristic of the third embodiment is weaker than that of the first embodiment and the second embodiment. However, even so, the horizontal viewing angle of the third embodiment is still larger than the conventional horizontal viewing angle.

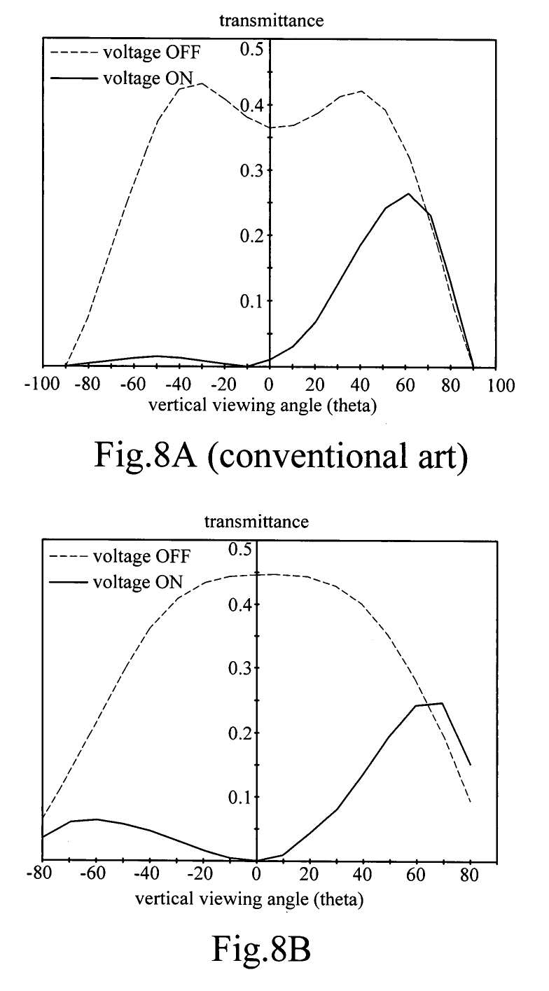

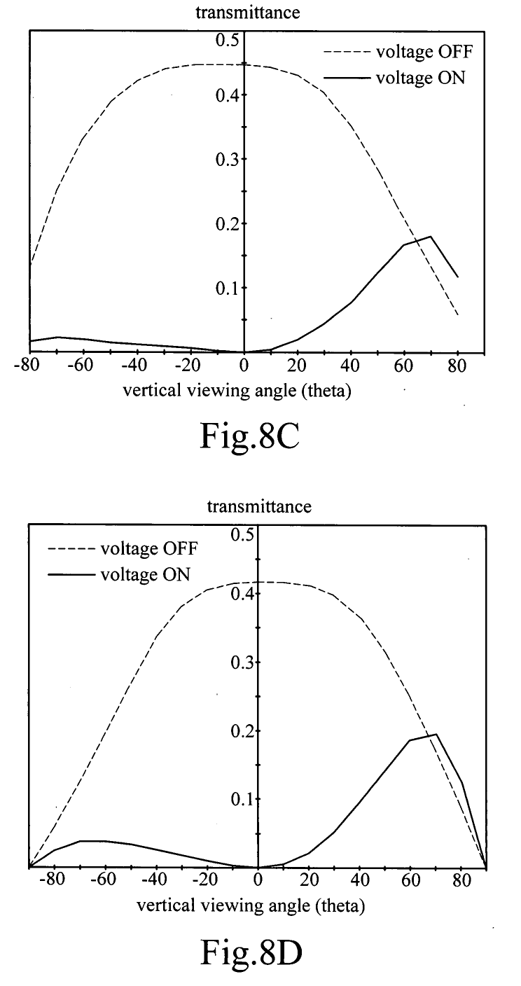

Next, referring to FIGS. 8A to 8D, they are vertical viewing angle characteristics of the transflective LCDs of the conventional circular polarizing compensating system and the transflective LCDs of the first to the third embodiments of the present invention in the transmitting region. FIG. 8A is a vertical viewing angle characteristic of the transflective LCD of the conventional wide-band circular polarizing compensating system in the transmitting region. The transmittance of the transmissive curve when the LC voltage is OFF is reduced at the vertical viewing angle of 0 degrees, such that the brightness of the front viewing angle is not desirable, and the transmittance curve when the LC voltage is ON has a significant fluctuation, which shows the effect of the dark-state region is poor. FIG. 8B is a vertical viewing angle characteristic of the first embodiment in the transmitting region. The transmittance of the transmissive curve when the LC voltage is OFF is increased at the vertical viewing angle of 0 degrees as compared with that of the conventional art, and the brightness of the front viewing angle is improved, but the transmittance curve when the LC voltage is ON still has a significant fluctuation. FIG. 8C is a vertical viewing angle characteristic of the second embodiment in the transmitting region. The transmittance of the transmissive curve when the LC voltage is OFF is high at the vertical viewing angle of 0 degrees, the brightness of the front viewing angle direction is high, and the transmittance curve when the LC voltage is ON has small fluctuation, so as to provide the preferred dark-state region, therefore, the LCP film has better compensating effect as compared with the retardation film. FIG. 8D is a vertical viewing angle characteristic of the third embodiment in the transmissive region. Although the transmittance of the transmissive curve when the LC voltage is OFF at the vertical viewing angle of 0 degrees is not as high as that of the first and second embodiments, but it achieves a higher brightness than the conventional art.

To sum up, in the transflective LCD of the present invention, as long as the slow axes of the two upper and lower retardation films are orthogonal to each other, and the LC cell is clipped, the same effect can be achieved. In the orthogonal polarizing compensating system, the relative relationship between the direction of slow axis and the LC director, the retardation value of the retardation films and the suitable phase difference of the LC cell are used together to obtain the most optimal phase difference, such that when the LC is not driven, a phase difference of about a half wave length (½ λ) is generated to achieve the bright state. When the LC is driven, the total phase difference of zero is generated to achieve the dark state. The LC cell being homogeneously-arranged or having the twisting effect is used together with suitable phase differences and slow axis angles of the retardation film, the transmissive optical mode with low dispersion, wide viewing angle, ultra-low dark state effect is achieved, without damaging the reflective mode. In addition, in the conventional circular polarizing compensating system, a plurality of retardation plates is required, whereas the present invention not only reduces the number of the used retardation plates, so as to reduce the manufacturing cost, such that the LCD becomes thinner, and the retardation film allows the enlarging of the LC twist angle in the LC cell, so as to reduce the yield of the defective products, and relatively reduces the loss of the retardation film.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A transflective liquid crystal display (LCD), comprising:
a first polarizer;
a first retardation film, located on the first polarizer;
a liquid crystal (LC) cell, located on the first retardation film, and having a LC layer, wherein the LC molecules of the LC layer are homogeneously arranged, an slow axis of the first retardation film is orthogonal to the LC alignment direction of the LC layer, and the LC cell further comprising at least one transmitting region and at least one reflecting region;
a second retardation film, located on the LC cell, wherein an slow axis of the second retardation film is parallel to the LC alignment direction of the LC layer;
a second polarizer, located on the second retardation film; and
a backlight module, located under the first polarizer.

2. The transflective LCD as claimed in claim 1, wherein the phase difference value of the first retardation film is 60-190 nm.

3. The transflective LCD as claimed in claim 1, wherein the phase difference value of the transmitting region is 200-380 nm.

4. The transflective LCD as claimed in claim 1, wherein the phase difference value of the reflecting region is 100-200 nm.

5. The transflective LCD as claimed in claim 1, wherein the phase difference value of the second retardation film is 60-190 nm.

6. The transflective LCD as claimed in claim 1, wherein each of the first retardation film and the second retardation film is formed by one of the materials of PC, Arton, Sina, Zeonor, or liquid crystal polymer (LCP).

7. The transflective LCD as claimed in claim 6, wherein the LC tilt angle of the LCP is 30-70 degrees, and the phase difference value of the LCP is 80-160 nm.

8. A transflective LCD, comprising:
a first polarizer;
a first retardation film, located on the first polarizer;
a LC cell, located on the first retardation film, and having a LC layer, wherein the LC molecules of the LC layer are in a twist mode, an slow axis of the first retardation film is orthogonal to the center direction of the twist angle of the LC molecules in the LC layer, and the LC cell further comprising at least one transmitting region and at least one reflecting region;
a second retardation film, located on the LC cell, wherein a slow axis of the second retardation film is parallel to the center direction of the twist angle of the LC molecules in the LC layer;
a second polarizer, located on the second retardation film; and
a backlight module, located under the first polarizer.

9. The transflective LCD as claimed in claim 8, wherein the phase difference value of the first retardation film is 60-190 nm.

10. The transflective LCD as claimed in claim 8, wherein the phase difference value of the transmitting region is 200-380 nm.

11. The transflective LCD as claimed in claim 8, wherein the phase difference value of the reflecting region is 100-200 nm.

12. The transflective LCD as claimed in claim 8, wherein the phase difference value of the second retardation film is 60-190 nm.

13. The transflective LCD as claimed in claim 8, wherein the twist angle of the LC molecules in the LC layer is 0-50 degrees.

14. The transflective LCD as claimed in claim 8, wherein each of the first retardation film and the second retardation film is formed by one of the materials of PC, Arton, Sina, Zeonor, or LCP.

15. The transflective LCD as claimed in claim 14, wherein the LC tilt angle of the LCP is 30-70 degrees, and the phase difference value of the LCP is 80-160 nm.

16. A transflective LCD, comprising:
a first polarizer;
a first retardation film, located on the first polarizer;
a LC cell, located on the first retardation film, and having a LC layer, and further comprising at least one transmitting region and at least one reflecting region;
a second retardation film, located on the LC cell, wherein a slow axis of the second retardation film is orthogonal to a slow axis of the first retardation film;
a second polarizer, located on the second retardation film, wherein the polarizing direction of the second polarizer is orthogonal to the polarizing direction of the first polarizer; and
a backlight module, located under the first polarizer;
wherein when the LC cell is in the driving state, the equivalent phase difference generated from the LC cell, the first retardation film, and the second retardation film is close to zero; when the LC cell is in the state that the voltage is off, the equivalent phase difference generated from the LC cell, the first retardation film, and the second retardation film is equal to a half wave length.

17. The transflective LCD as claimed in claim 16, wherein the phase difference value of the first retardation film is 60-190 nm.

18. The transflective LCD as claimed in claim 16, wherein the LC molecules of the LC layer are homogeneously arranged.

19. The transflective LCD as claimed in claim 16, wherein the LC molecules of the LC layer are in a twist mode.

20. The transflective LCD as claimed in claim 19, wherein the twist angle of the LC molecules in the LC layer is 0-50 degrees.

21. The transflective LCD as claimed in claim 16, wherein the phase difference value of the transmitting region is 200-380 nm.

22. The transflective LCD as claimed in claim 16, wherein the phase difference value of the reflecting region is 100-200 nm.

23. The transflective LCD as claimed in claim 16, wherein the phase difference value of the second retardation film is 60-190 nm.

24. The transflective LCD as claimed in claim 16, wherein each of the first retardation film and the second retardation film is formed by one of the materials of PC, Arton, Sina, Zeonor, or LCP film.

25. The transflective LCD as claimed in claim 24, wherein the LC tilt angle of the LCP is 30-70 degrees, and the phase difference value of the LCP is 80-160 nm.
